(19) United States
(12) Patent Application Publication
(10) Pub. No.: US 2008/0151559 A1
(43) Pub. Date: Jun. 26, 2008

(54) MAGNETIC MOUNT LAMP

(76) Inventor: Chi-Wen CHEN, Taipei City (TW)

Correspondence Address: LADAS & PARRY LLP, 224 SOUTH MICHIGAN AVENUE, SUITE 1600, CHICAGO, IL, 60604, US

(21) Appl. No.: 11/696,253

(22) Filed: Apr. 4, 2007

(30) Foreign Application Priority Data
Dec. 26, 2006 (CN) 200620173484.0

(51) Int. Cl. F21V 21/096

(52) U.S. Cl. 362/368; 362/396

(57) ABSTRACT

A magnetic mount lamp includes a supporting base, a lamp supported on the supporting base, at least one magnetic element secured to the supporting base, and a hanger attached magnetically to the supporting base through the magnetic element. The hanger includes a U-shaped mounting plate attached magnetically to the supporting base, and a hook mounted rotatably on the U-shaped mounting plate.

### CROSS-REFERENCE TO RELATED APPLICATION

This application claims priority of Chinese Patent Application No. 200620173484.0, filed on Dec. 26, 2006.

### BACKGROUND OF THE INVENTION

1. Field of the Invention

The invention relates to a lamp, more particularly to a magnetic mount lamp.

2. Description of the Related Art

Working lamps are generally mounted to an object so that a worker can work effectively with both hands rather than holding a lamp on one hand. One kind of the working lamps is a magnetic mount lamp. A conventional magnetic mount lamp is generally attached to an object through magnets. As such, the object to be attached is required to be made from a material, which can be magnetized in a magnetic field, such as iron, cobalt, etc. However, there might be no such objects in the working site. Therefore, the conventional magnetic mount lamp is sometimes not convenient to use.

### SUMMARY OF THE INVENTION

Therefore, the object of the present invention is to provide a magnetic mount lamp that is convenient to use and that can overcome the aforesaid drawback associated with the prior art.

Accordingly, a magnetic mount lamp of this invention comprises a supporting base, a lamp supported on the supporting base, at least one magnetic element secured to the supporting base, and a hanger attached magnetically to the supporting base through the magnetic element.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a preferred embodiment of a magnetic mount lamp according to the invention;

FIG. 2 is an assembled perspective view of the preferred embodiment to illustrate how a magnet element is retained on a first housing half of a housing;

FIG. 3 is a perspective view to illustrate the configuration of a second housing half of the housing of the preferred embodiment; and

FIG. 4 is an exploded perspective view of the preferred embodiment to illustrate how a hanger is attached to a supporting base.

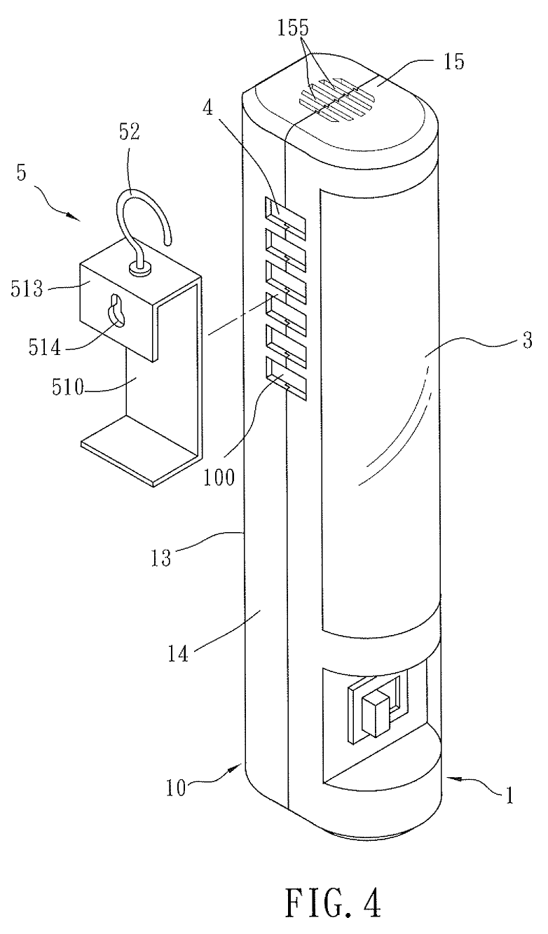

### DETAILED DESCRIPTION OF THE PREFERRED EMBODIMENT

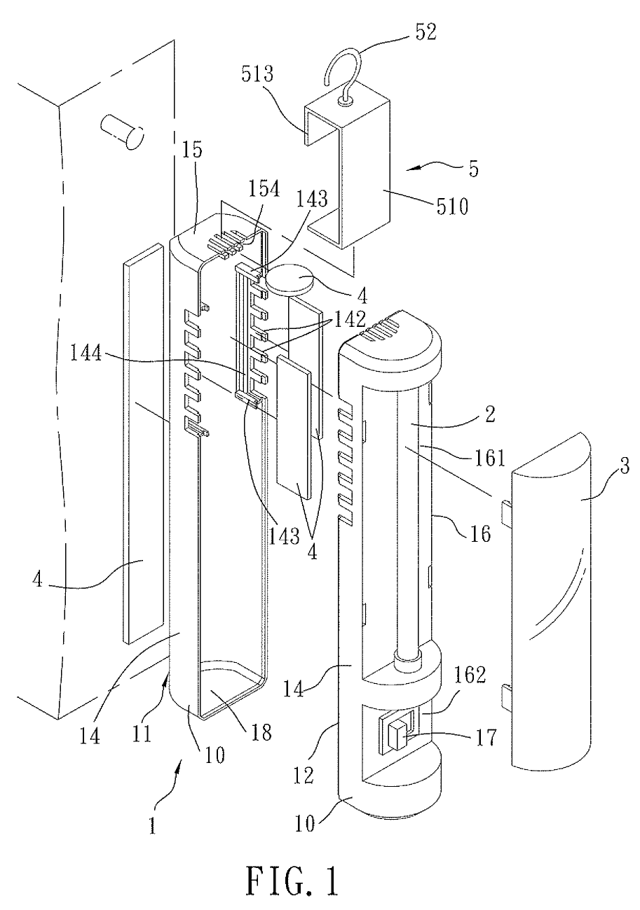

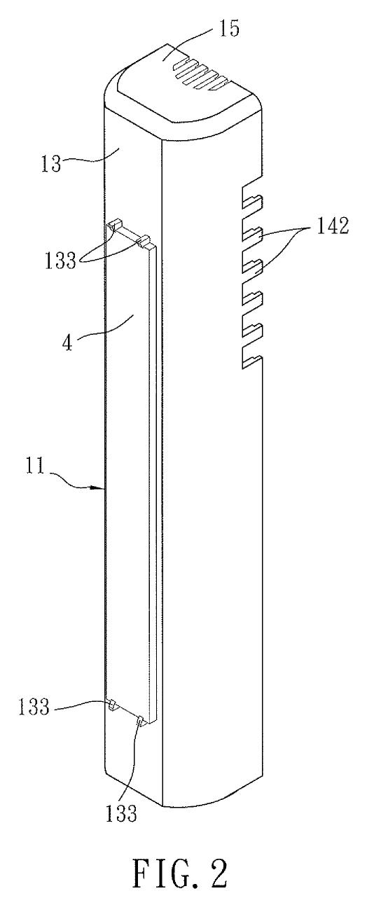

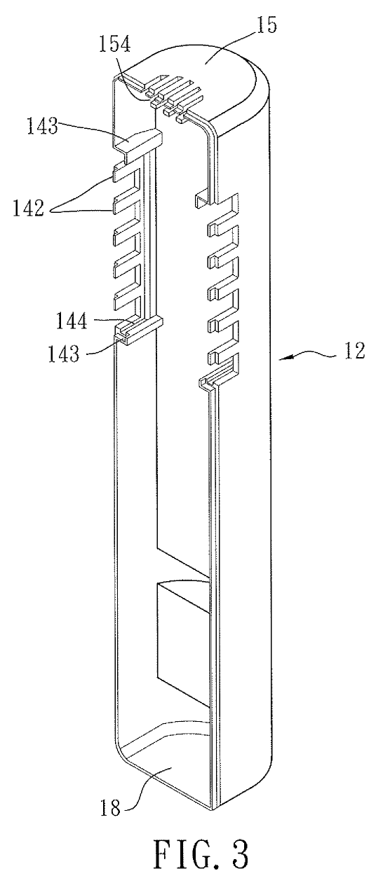

As shown in FIGS. 1, 2, and 3, the preferred embodiment of a magnetic mount lamp according to this invention includes a supporting base 1, a lamp 2, a transparent cover 3, four magnetic elements 4, and a hanger 5.

The supporting base 1 includes a housing 10 that defines an inner space 100 therein and that has first and second housing halves 11, 12 connected detachably to each other. The housing 10 includes front and rear walls 16, 13, two side walls 14 interconnecting the front and rear walls 16, 13, and top and bottom walls 15, 18. Each of the side walls 14 and the top and bottom walls 15, 18 is divided into two halves, each of which forms a portion of a respective one of the first and second housing halves 11, 12 of the housing 10. The front wall 16 defines an upper recess 161 and a lower recess 162. The lamp 2 is mounted in the upper recess 161. A power switch 17 is mounted in the lower recess 162. The rear wall 13 is formed with four retaining protrusions 133 that cooperatively define a retaining space thereamong.

Each of the side walls 14 of the housing 10 is formed with a plurality of side through-holes 145. Each of the halves of each of the side walls 14 is formed with a plurality of spaced apart engaging teeth 142 and upper and lower retaining protrusions 143 protruding into the inner space 100 in the housing 10. The engaging teeth 142 of one of the halves of each of the side walls 14 engage respectively the engaging teeth 142 of the other of the halves of the respective sidewall 14 and cooperate with the engaging teeth 142 of the other of the halves of the respective side wall 14 to define the side through-holes 145 in the respective one of the side walls 14. The upper and lower retaining protrusions 143 of one of the halves of each of the side walls 14 cooperate with the upper and lower retaining protrusions 143 of the other of the halves of the respective one of the side walls 14 to define a side retaining recess 144 thereamong in spatial communication with the inner space 100.

In a like manner, the top wall 15 is formed with a plurality of top through-holes 155, and a top retaining recess 154 in spatial communication with the inner space 100.

A transparent cover 3 is detachably mounted on the front wall 16 of the housing 10 so as to cover the upper recess 161 in the front wall 16.

Three of the four magnetic elements 4 are respectively retained in the side retaining recesses 144 in the side walls 14 and the top retaining recess 154 in the top wall 15. The remaining one of the magnetic elements 4 is retained in the retaining space among the retaining protrusions 133 on the rear wall 13 of the housing 10.

The hanger 5 can be made from a material, such as iron, cobalt, nickel, etc., which can be magnetized in a magnetic field, or a magnet The hanger 5 includes a U-shaped mounting plate 510 and a hook 52 mounted rotatably on the U-shaped mounting plate 510. The hanger 5 further includes an auxiliary mounting plate 513 that extends transversely from one end of the U-shaped mounting plate 510 and that is formed with a hanging hole 514.

Since there are four magnetic elements 4 disposed in different parts, i.e., the rear wall 13, the side walls 14 and the top wall 15 in this embodiment, of the housing 10, the hanger 5 can be attached magnetically and selectively to different parts of the housing 10 of the supporting base 1 through a corresponding one of the magnetic elements 4 based on actual requirements during use. Moreover, the design of the hanger 5 permits the magnetic mount lamp to be hung either through the hook 52 or through the hanging hole 514 in the auxiliary mounting plate 513 of the hanger 5.

Since the attraction force between the hanger 5 and each of the magnetic elements 4 is relatively strong, separating them is relatively difficult when they are in direct contact with each other. Hence, it is desirable to avoid direct contact of the hanger 5 with any one of the magnetic elements 4 during use. However, since the housing 10 has a relatively thick wall, the attraction force between the hanger 5 and each of the magnetic elements 4, which are retained at the side walls 14 and the top wall 15, may be insufficient to prevent undesired separation therebetween during use. Hence, formation of the side and top through-holes 145, 155 results in a suitable extent of the attraction force between the hanger 5 and each of the magnetic elements 4.

Accordingly, the preferred embodiment can not only be attached magnetically to an object, which is made from a material that can be magnetized in a magnetic field, on a working site but can also be hung up through a protrusion on a working site.

It should be noted that, while this invention is exemplified using three rectangular and one round magnetic elements 4 retained on the housing 10 (see FIG. 1), other shapes of magnetic elements 4 may be employed in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A magnetic mount lamp comprising:
a supporting base;
a lamp supported on said supporting base;
at least one magnetic element secured to said supporting base; and
a hanger attached magnetically to said supporting base through said magnetic element.

2. The magnetic mount lamp as claimed in claim 1, wherein said hanger includes a U-shaped mounting plate attached magnetically to said supporting base, and a hook mounted on said U-shaped mounting plate.

3. The magnetic mount lamp as claimed in claim 2, wherein said hook is rotatably mounted on said U-shaped mounting plate.

4. The magnetic mount lamp as claimed in claim 2, wherein said hanger further includes an auxiliary mounting plate extending transversely from one end of said U-shaped mounting plate and formed with a hanging hole.

5. The magnetic mount lamp as claimed in claim 1, wherein said supporting base includes a housing defining an inner space therein and having a wall that is formed with a side retaining recess in spatial communication with said inner space, said magnetic element being retained in said side retaining recess, said hanger being attached magnetically to an exterior of said wall of said housing through said magnetic element.

6. The magnetic mount lamp as claimed in claim 5, wherein said wall of said housing is formed with a plurality of through-holes disposed between said hanger and said magnetic element.
